(19) United States
(12) Patent Application Publication
(10) Pub. No.: US 2009/0043831 A1
(43) Pub. Date: Feb. 12, 2009

(54) Smart Solid State Drive And Method For Handling Critical Files

(75) Inventors: Nick Antonopoulos, San Jose, CA (US); Sree M. Iyer, San Jose, CA (US); Arockiyaswamy Venkidu, Santa Clara, CA (US); Arunprasad Ramiya Mothilal, Santa Clara, CA (US)

Correspondence Address: The TPL Group, 20400 Stevens Creek Blvd., Fifth Floor, Cupertino, CA, 95014, US

(73) Assignee: MCM PORTFOLIO LLC, Cupertino, CA (US)

(21) Appl. No.: 12/040,666

(22) Filed: Feb. 29, 2008

Related U.S. Application Data
(60) Provisional application No. 60/955,341, filed on Aug. 11, 2007.

(51) Int. Cl. G06F 12/02; G06F 12/00

(52) U.S. Cl. 707/205; 711/103; 707/E17.01; 711/E12.001; 711/E12.008

(57) ABSTRACT

A method and apparatus for dynamically distributing data to an appropriate storage device based on the significance of the data. In one embodiment the method determines the significance of a data file using the format of the data file. The method also includes identifying a storage device and memory location of the storage device to write the data. In a software implementation, a computer system employs a filter driver and/or a device driver to identify and store data files. In another embodiment, a storage controller includes a state machine that initiates and executes firmware to determine the data file format and also the storage device location.

### RELATED APPLICATION

This application claims the benefit of U.S. Provisional Application No. 60/955,341 filed Aug. 11, 2007.

### COPYRIGHT NOTICE/PERMISSION

A portion of the disclosure of this patent document contains material which is subject to copyright protection. The copyright owner has no objection to the facsimile reproduction by anyone of the patent document or the patent disclosure as it appears in the Patent and Trademark Office patent file or records, but otherwise reserves all copyright rights whatsoever.

### FIELD OF INVENTION

This invention relates to distributing data to storage devices based on the significance of the content of the data.

### BACKGROUND

With the advances of portable electronics such as portable computers and MP3 players the need for high performance, high reliability, and low cost nonvolatile storage devices is increasing rapidly. Hard disks and flash memory are the two types of nonvolatile storage devices used for storage and transfer of data between computers and other digital products. Both hard drives and flash memory have their own advantages and disadvantages. For instance, hard disks have higher data reliability and lower cost than flash memory, but have severe mechanical and electrical limitations; hard disks take a significant amount of time to respond to and complete an I/O request. Flash memory, on the other hand, offer faster read access times and better shock resistance than hard disks. Flash memory can also withstand extreme conditions with respect to temperature, pressure and humidity.

Flash memory stores information in an array of floating gate transistors called cells. Flash memory devices can be a single cell level (SLC) flash in which each cell stores only one bit of information, multiple cell level (MLC) flash, where more than one bit per cell is stored, or a combination of the two. Even though flash memory devices offer advantages over the hard disks, they have limitations with respect to the cost per byte and capacity. For instance, SLC flash has limitations with respect to capacity and has a relatively high cost per byte, while MLC flash has limitations such as performance and reliability.

As one kind of storage device does not clearly solve all the problems of performance, data reliability and low cost, new hybrid storage devices, including a wide range of storage devices, are being developed. These hybrid storage devices, as well as systems with a combination of nonvolatile storage devices, require a storage controller that can distribute data to an appropriate storage device based on the significance of the data file.

For example, a computer system may include multiple storage devices such as hard drive and a combination of MLC and SLC flash memory. If a user needs to store information that contains critical data and requires rapid access, the controller should store that data in the SLC flash memory because SLC flash memory offers high data reliability combined with speed. Similarly, if a data file does not contain critical information, the storage controller may store the data file in less expensive MLC flash memory. The user may assign data files with certain formats such as, for example, .doc, and .xls as critical and file formats such as jpeg, .bmp, .pdf, and .mp3 as non-critical.

The present invention includes a method and mechanism that distributes data to different storage devices based on the significance of data content, requirements of file access time, and frequency of file access. The significance of the data content may be determined by the format of its associated data file.

The invention may also be practiced in software.

### SUMMARY OF THE INVENTION

A method and apparatus for dynamically distributing data to an appropriate storage device based on the significance of the data is described. In one embodiment the method determines the significance of a data file using the format of the data file. The method also includes identifying a storage device and memory location of the storage device to write the data.

In a software implementation, a computer system employs a filter driver and/or a device driver to identify and store data files (for the purposes of this application, the term “filter driver” also encompasses “device driver”). In a hardware implementation, a storage controller includes a state machine that initiates and executes firmware or other code. The storage controller determines data file formats and storage device locations. Identifying a file type is one method of determining the critical or non-critical nature of data files. However, it is also within the scope of this invention for software or a controller to examine other attributes such as, but not limited to, data file content, access time requirements, and frequency of access. Depending upon data file attributes, data files may be stored in an appropriate location, such as SLC flash memory, MLC flash memory, or hard disk.

The details of the present invention, both as to its structure and operation, and many of the attendant advantages of this invention, can best be understood in reference to the following detailed description, when taken in conjunction with the accompanying drawings, in which like reference numerals refer to like parts throughout the various views unless otherwise specified, and in which:

### BRIEF DESCRIPTION OF THE DRAWINGS

FIG. 1 illustrates logic of a sample disk input/output (I/O) system.

FIG. 2 is a flow chart of a filter driver in accordance with the present invention.

FIG. 3 is a block diagram of a hardware implementation of the present invention.

FIG. 4 illustrates a method of operation of the present invention involving examining data file format.

FIG. 5 illustrates a method of operation of the present invention involving examining data content and access time requirements.

FIG. 6 illustrates a method of operation of the present invention involving decision matrix table lookup.

FIG. 7 illustrates an example of decision tree determination of data file storage location.

### DETAILED DESCRIPTION

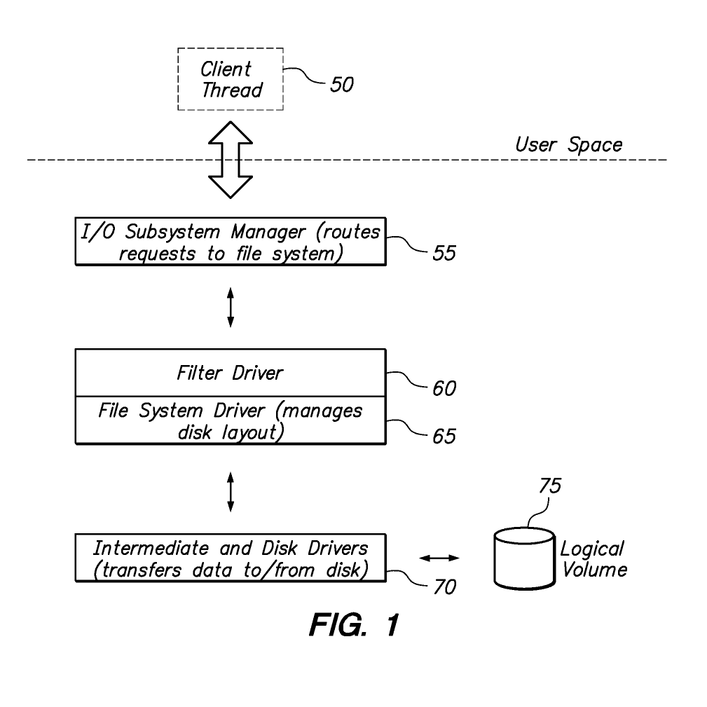

The logic of a sample disk software input/output (I/O) system is shown in FIG. 1. A request for disk I/O is forwarded from a user, application, or client thread 50 to an I/O subsystem manager 55 which routes requests to the file system. The present invention may reside in a filter driver 60 which is seamlessly connected to a file system driver 65 that manages disk layout. If a request is to write data, the filter driver 60 examines data file extensions, and depending on type of file, notifies the file system driver 65 where to store the file. Data is then forwarded to intermediate disk drivers 70, which in turn connect to logical volume(s) 75.

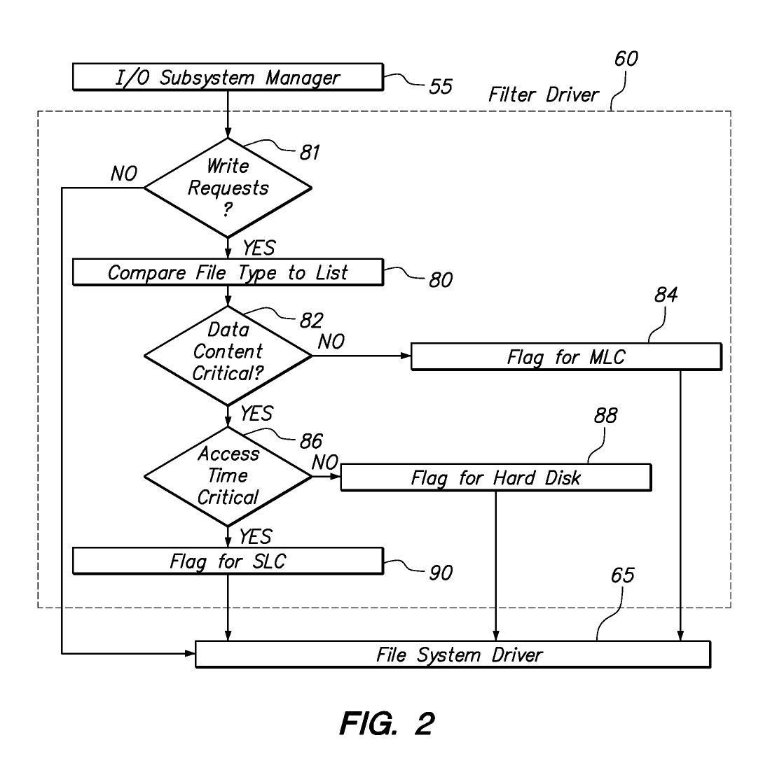

FIG. 2 is a more detailed view of the filter driver 60 in the software implementation of the invention. As in FIG. 1, the I/O subsystem manager 55 routes requests to the file system. The filter driver 60 accepts the requests, and if it does not receive a write request 81 (i.e., receives a read request), it forwards the request to the file system driver 65. On the other hand, if filter driver 60 receives a write request 81, the file extension is compared to a list of extensions 80. If the file extension indicates that the file does not contain critical data (step 82), the file may be flagged for storage in an MLC device (step 84) and forwarded to the file system driver 65.

Instead, if the file extension indicates that the contents of the file in fact contain critical data, the file may be further examined to determine if access time is critical (step 86). If not, the file may be flagged for storage in a hard disk (step 88) and forwarded to the file system driver 65. If the data is time critical, the file may be flagged for storage in an SLC device (step 90), and then forwarded to the file system driver 65.

Other types of nonvolatile memory may be substituted for SLC, MLC, and hard drive devices and still be within the scope of this invention.

To determine if the data is time critical, the software may record and use the history of respective data file usage. A user or application may mark data as time critical. Or an expert or queuing system may be employed.

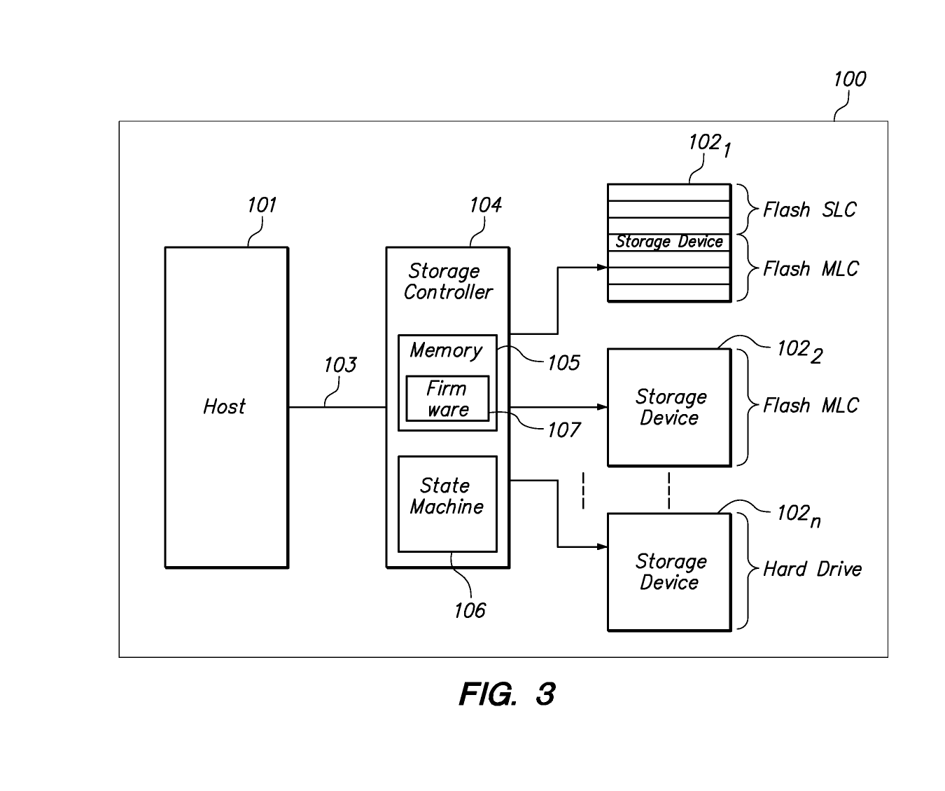

The invention may also reside in a controller. FIG. 3 shows a block diagram of a controller implementation of the present invention 100, which includes a host system 101, storage devices 102₁ to 102ₙ, peripheral interface (such as a bus) 103 and a storage controller 104. The present invention also includes a state machine 106 and memory 105 where the firmware 107 is stored. Host 101, on receiving the request to write data to one storage device, sends a command over bus 103 to the storage controller 104. On receiving the command, the storage controller 104 initiates the state machine 106 and executes the firmware 107 to identify the format of the data file. The storage controller 104, on determining the format of the data file, identifies the significance of the content of the data file and writes the data file to the appropriate memory location of the storage devices. In one instance, the storage device may be SLC flash memory. In another implementation, storage device 102₁ may be a combination single level cell (SLC) and a multiple level cell (MLC) flash memory. The storage device 1022 also may be, for example, only MLC flash memory, while storage device 102ₙ may be but is not limited to hard drive. The order and type of nonvolatile storage devices are not important as long as the storage controller 104 can identify storage device type and location. The storage controller 104 presents the storage devices 102₁ to 102ₙ as one logical volume to the host system 101.

The storage controller 104 may employ tables, such as Table 1 and Table 2 (see below), to determine the appropriate storage device.

To determine if the data is time critical, a user or application may flag files. Alternatively, the storage controller may record and use the history of respective data file usage. Or a fuzzy logic, expert, or queuing system may be employed.

The storage controller need not be a separate peripheral device. It may reside on a chip connected to host 101.

In one embodiment of the present invention, the appropriate storage device can be predetermined based on the format of the data file. In another embodiment, the peripheral interface 103 may include but is not limited to USB interface, IDE interface, or SATA interface. In yet another embodiment, the storage controller 104 can identify the different kinds of storage devices such as, but not limited to, memory sold under the trademarks CompactFlash, MultiMediaCard, Memory Stick, and Secure Digital Card. In fact, storage controller 104 may identify any number of different removable flash memory types, including those compatible with USB flash drives. Moreover, the storage controller 104 can distribute the data to the appropriate memory location of the storage devices.

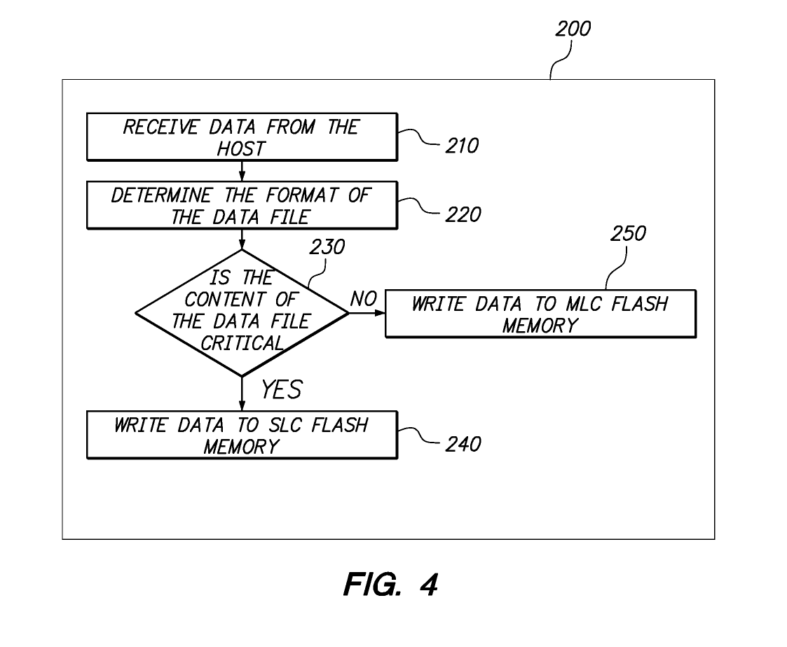

FIG. 4 illustrates one embodiment of method 200 for dynamically determining the format of the data file and writing data to the appropriate memory, such as, but not limited to SLC flash memory, MLC flash memory, and hard disk. With reference to FIG. 3, the method includes receiving the data file from the host system 101 using the peripheral interface 103 (step 210), determining the format of the data file using the state machine 106 (step 220) and determining if the content of the data file is critical based on the data file format (step 230). If the data file contains critical information, which is determined by the format of the data file, the data file is written to the SLC flash memory of the storage device 102₁ (step 240). If the data file does not contain critical information then the data file is written to the MLC flash memory of the storage device 1022 (step 250).

In another embodiment, the data file includes content critical information that does not require short access time. In this case, the data may be written to the storage device 102ₙ, hard drive. Optionally, data received by storage controller 104 can be encrypted by using an encryption key depending on the format of the data file.

Storage controller 104 may detect data file system type installed on the storage device by reading system ID field in the bootable partition located in master boot record of the storage device. A short list of typical system ID types is listed in Appendix A. Once the file system type is determined, file system structures can be located and content of critical and non-critical data files can be stored in appropriate areas. Appendix B lists one such search where a special folder is located that contains a special file.

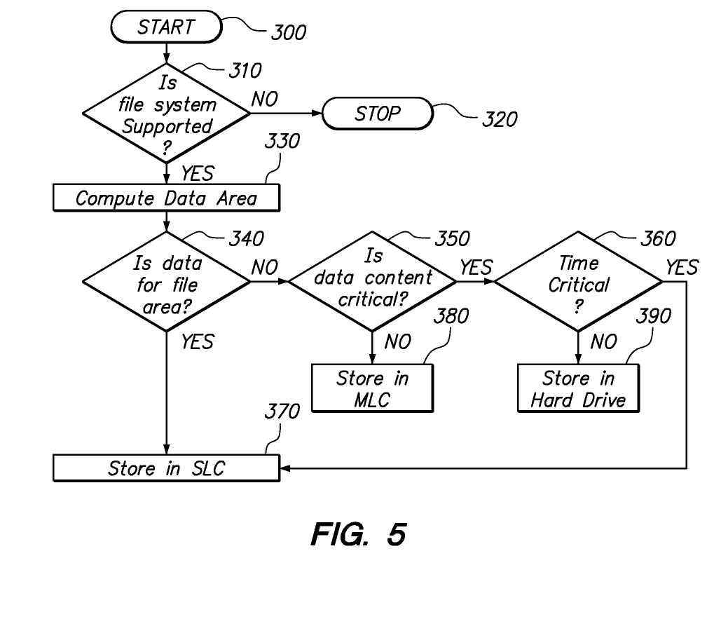

FIG. 5 is an example of a method for determining where to store data in accordance with the present invention. After the decision to start (step 300), it is determined whether a file system is supported (step 310). If not, the procedure halts (step 320). If the file system is supported, a data area is computed (step 330). Then it is determined if the data are for the file system (step 340). If so, then the file is stored in SLC memory (step 370). If the data are not for the file system, then it is determined if the data are content critical (step 350). If they are not critical, then the data are stored in MLC memory (step 380). If the data are critical, then it is determined if they are access time critical (step 360). If so, data are stored in SLC memory (step 370). If data are not time critical, then they are stored in a hard drive (step 390).

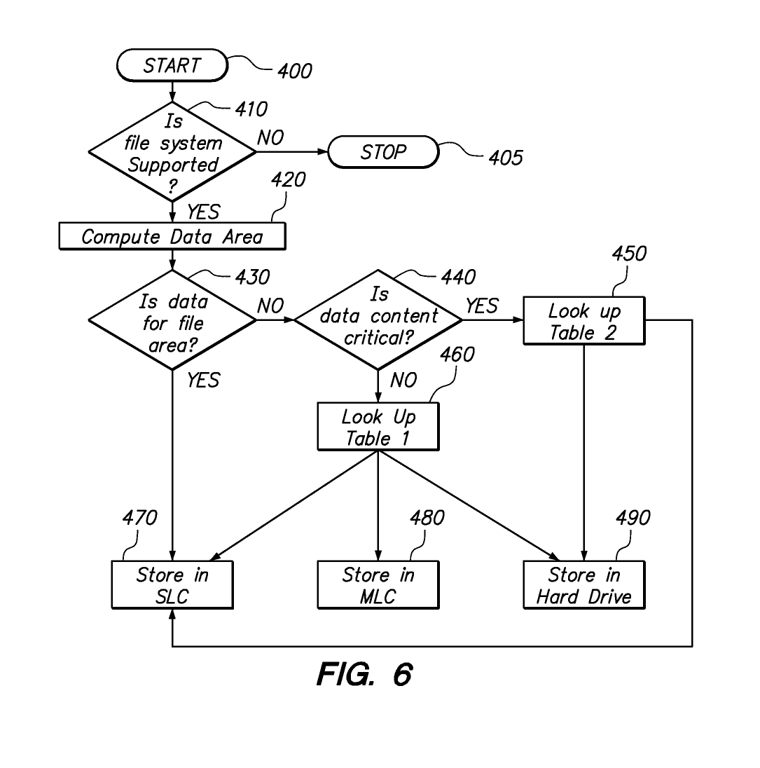

FIG. 6 is an example of a method for determining where to store data using decision matrix tables. After the decision to start (step 400), it is determined whether a file system of a file containing the data is supported (step 410). If not, the procedure halts (step 405). If the file system is supported, a data area is computed (step 420). Then it is determined if the data are for a file system (step 430). If so, then the file is stored in SLC memory (step 470). If the data are not for a file area, then it is determined if the data are content critical (step 440). If they are not critical, then a decision matrix, Table 1 for example, is employed (step 460).

Example table, Table 1, is a decision matrix showing how access time non-critical data may be handled. In one situation, in which there is light writing and heavy reading, data are best stored in MLC memory (step 480). If data access is medium, then hard disk would be employed (step 490). In another case, where there is frequent writing and infrequent reading, SLC would be chosen (step 470).

TABLE 1
Non-Critical Data

| | Heavy Write | Medium Write | Light Write |
|---|---|---|---|
| Heavy Read | SLC | MLC | MLC |
| Medium Read | SLC | Hard Disk | Hard Disk |
| Light Read | SLC | Hard Disk | Hard Disk |

If at step 440, data are determined to be content critical, then another decision matrix, Table 2 for example, is employed (step 450).

Example table, Table 2, is a decision matrix showing how access time critical data may be handled. In this case, data which are lightly written and heavily read are stored in SLC memory (step 470). If data access is medium, then hard disk would be employed (step 490). In the situation in which there is heavy writing and light reading, SLC memory may be used (step 470).

TABLE 2
Critical Data

| | Heavy Write | Medium Write | Light Write |
|---|---|---|---|
| Heavy Read | SLC | SLC | SLC |
| Medium Read | SLC | Hard Disk | Hard Disk |
| Light Read | SLC | Hard Disk | Hard Disk |

In addition to determining where to store data based on file type, content, and access time requirements, another factor, frequency of access, may be employed. Appendix C describes how data may be stored depending on how often it is accessed. This may stand alone as the sole criteria for where to store data, or it may work in tandem with software or the storage controller to weigh all the factors in determining an optimal storage location. While four factors are described herein (file type, content, access time requirements, and frequency of access), additional factors may also be used to determine storage locations.

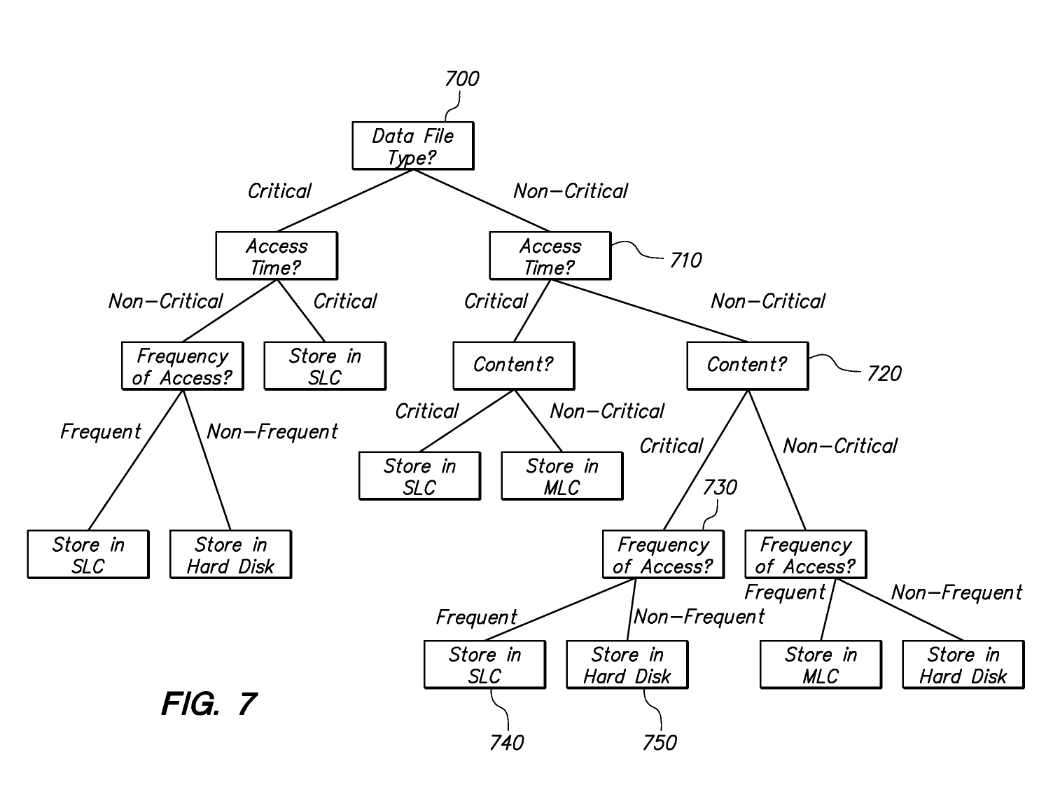

FIG. 7 shows an example of using a decision tree to determine where to store data based on a hierarchy of four factors. In this instance, data file type is the highest priority factor; access time requirements is next; data content the third; and frequency of access the lowest. One way to traverse the tree is:

determining that the data file type is non-critical (step 700),

determining that the access time requirements are non-critical (step 710),

determining that the data file content is critical (step 720),

if data is frequently accessed (step 730), storing data in SLC memory (step 740) else

storing data in hard disk memory set 750).

As shown in FIG. 7, there are a number of different ways to traverse the example tree. And there are any number of different trees which may be constructed. In one embodiment, decision factors may include the wear level dependency of memory devices.

In traversing the decision tree, a number of binary decisions are made. However, it is not necessary to assign the various factors an “all or nothing” status. As suggested in Appendix D, factors may have various weights. An expert or fuzzy logic system (collectively referred to as “artificial intelligence”) may then evaluate the factors in determining storage location(s). Moreover, the contents of a data file could be spread across storage media, depending on how the factors relate to various parts of the data file.

While the particular method and apparatus as herein shown and described in detail is fully capable of attaining the above-described objects of the invention, it is to be understood that it is the presently preferred embodiment of the present invention and is thus representative of the subject matter which is broadly contemplated by the present invention, that the scope of the present invention fully encompasses other embodiments which may become obvious to those skilled in the art, and that the scope of the present invention is accordingly to be limited by nothing other than the appended claims, in which reference to an element in the singular means “at least one”. All structural and functional equivalents to the elements of the above-described preferred embodiment that are known or later come to be known to those of ordinary skill in the art are expressly incorporated herein by reference and are intended to be encompassed by the present claims. Moreover, it is not necessary for a device or method to address each and every problem sought to be solved by the present invention, for it to be encompassed by the present claims. Furthermore, no element, component, or method step in the present disclosure is intended to be dedicated to the public, regardless of whether the element, component, or method step is explicitly recited in the claims.

### APPENDIX A

Information on file systems is widely available and can be found in web sites such as Wikipedia and OSData, and also in books such as File Systems: Design and Implementation by Daniel Grosshans, published by Prentice Hall, Windows XP Professional by Dan Baiter, published by Que Publishing etc.

ID Name (located at Offset 4 of each 16-byte Partition record on the MBR)

### 00 Empty

Un-used partition table entry. (All other fields should be zero as well.) Unused area is not designated.

### 01 DOS 12-bit FAT

This is found in early versions of Disk Operating System (DOS), a family of single-user operating systems for PCs. The type 01 is for partitions up to 15 MB.
   02 XENIX root

### 03 XENIX/usr

Xenix is an old port of Unix V7.

### 04 DOS 3.0+16-bit FAT (up to 32M)

### 05 DOS 3.3+Extended Partition

An extended partition is a box containing a linked list of logical partitions.
   06 DOS 3.31+16-bit FAT (over 32M)

### 07 Windows NT NTFS

### 0b WIN95 OSR2 FAT32

Partitions up to 2047 GB.

### 0c WIN95 OSR2 FAT32, LBA-mapped

Extended-INT13 equivalent of 0b above.

### 0e WIN95: DOS 16-bit FAT, LBA-mapped

0f WIN95: Extended partition, LBA-mapped
Windows 95 uses 0e and 0f as the extended-INT13 equivalents of 06 and 05.

### APPENDIX B

After the firmware has successfully detected the presence of a storage device, it finds the bin file as follows:
1. Read the MBR, located at Logical Block Address (LBA) of 0 from the media.
2. Get the Disk Boot Record (DBR) LBA Address from offset 1C6h of MBR data.
3. Read the DBR and get the 29 bytes of BIOS Parameter Block (BPB) structure from offset 0Bh of DBR data.
4. Read the value of number of Root entry from the BPB. If the value of Root Entry is 0x200 then Partition is FAT12 or FAT16. If the value of number of root entry is zero then partition is FAT32.
5. Calculate LBA address of Root Directory by doing the below calculation from the values read from the BPB, as mentioned in Step 7 below.
6. For FAT32 partition BPB have more fields compared to FAT16. Sector per Fat field for FAT 32 is not the same as FAT 16.
7. For FAT12, FAT16 and FAT32 partitions, the hidden sector is a Double WORD (DWORD) data so all four bytes should be read.

LBA address of Root Directory=Number of hidden sectors+(Sectors per FAT*2)+Number of reserve sectors
8. Check whether DMOEIBIN folder is present in the Root Directory by reading from the LBA address calculated in step 5.
9. The relevant BIN file will be located inside this folder.

### APPENDIX C

1. Identify Hot & Cold Data Blocks using Static Wear Leveling.
2. A hot data block is the one that gets accessed frequently, while a cold data block gets accessed infrequently.
3. Idea is to assign Hot Data Blocks to SLC NAND and assign Cold Data Blocks to MLC NAND.
4. Originally, write all data temporarily onto SLC NAND and have a scheduler to move the data from SLC to MLC NAND according to its write frequency.
5. There are many ways to distinguish whether the data block is hot or cold.
6. One such method is to track the write/erase count of logical data blocks (not physical blocks).
7. A scheduler can track the logical data block's write/erase count and move the infrequently accessed block to MLC NAND.
8. A programmable counter shall be used to set the write/erase count limit with which the controller determines whether the logical data block is hot or cold.
9. This logic can work in tandem with application software which in-turn facilitates the controller to determine whether the data block is critical or non-critical.

### APPENDIX D

1. The hybrid storage system controller, or host software, may have artificial intelligence with which it can set the criticality using fuzzy logic algorithm, e.g., distinguishing the criticality using an expert system.
2. Moreover, firmware can auto-detect the file system and give weight to data access. A fuzzy approach may be implemented to weigh whether the incoming data is critical or not.
3. For example, firmware may identify whether the incoming writes are file system writes or data writes. If the incoming writes are file system writes, then we shall give more weight for the data block to stay in SLC NAND and if the incoming writes fall onto data area with respect to its file system then the firmware can consider the data block as fuzzy. Depending upon future access, firmware will decide to keep the data block in SLC or MLC NAND.
4. An expert system with which the firmware identifies the criticality of data blocks.
5. For example, firmware may walk through the file system data, find FAT Tables, root directory and the other folders to identify the nature of the data. We can interpret the nature of the data as .XLS, .DOC, .PDF, .JPG, .BMP, .MPEG, etc.
6. A programmable table with which the firmware can determine whether to keep the files in SLC or in MLC NAND. Firmware shall communicate with application software with which above table can be fine-tuned and provide the necessary data for the expert analysis module. Having application software allows the system to fine tune its expert system to the usage environment.

We claim:

1. A filter driver, comprising:
means for determining if file data are critical, means for assigning file data storage location based upon critical status of the file data, and
means for notifying a file system driver of assigned file data storage location.

2. The filter driver of claim 1, wherein the critical status of the file data is determined based on content of the file data.

3. The filter driver of claim 1, wherein the critical status of the file data is determined based on the access time requirement of the file data.

4. The filter driver of claim 1, wherein the critical status of the file data is determined based on combining the critical nature of one or more members of the group comprising format of content of the file data, access time requirements of the file data, content of the file data, frequency of access of the file data, and wear level dependency of the data storage location.

5. The filter driver of claim 4, wherein the critical nature of the one or more members of the group is given a weight, and wherein the means for assigning file data storage is determined by artificial intelligence.

6. A method for storing file data in nonvolatile memory comprising:
accessing a filter driver wherein the accessing comprises:
determining if file data are critical,
assigning file data storage location based upon critical status of the file data, and
notifying a file system driver of assigned file data storage location.

7. The method of claim 6, wherein determining the critical status of the file data is based on determining content of the file data.

8. The method of claim 6, wherein determining the critical status of the file data is based on determining access time requirement of the file data.

9. The method of claim 6, wherein determining the critical status of the file data is based on determining combination of content of the file data and access time requirement of the file data.

10. A system for storing critical and non-critical data comprising:
a host,
the host in communication with a storage controller,
the storage controller comprising a state machine and associated memory,
the storage controller in communication with more than one non-volatile memories,
means for storing critical data in one or more of the non-volatile memories,
means for storing non-critical data in one or more of the non-volatile memories.

11. The system of claim 10, wherein the non-volatile memory is selected from the group comprising SLC memory, MLC memory, and hard disk memory.

12. The system of claim 10, wherein critical data is stored in non-volatile memory selected based on content of the file data.

13. The system of claim 10, wherein critical data is stored in non-volatile memory selected based on access time requirement of the file data.

14. The system of claim 10, wherein critical data is stored in non-volatile memory based on combination of content of the file data and access time requirement of the file data.

15. A method of storing critical data in one or more than one non-volatile memories comprising:
determining format of data,
determining if the format of data is critical, and
storing data in one or more non-volatile memories based on critical status of the format of data.

16. The method of claim 15 wherein the non-volatile memories are selected from the group comprising SLC memory, MLC memory, and hard disk memory.

17. A method of storing data in one or more of more than one non-volatile memories comprising:
computing data area of supported file system containing data,
storing data in one or more non-volatile memories if data is for file area,
determining if data is critical if data is not for file area,
storing critical data in one or more non-volatile memories, and
storing non-critical data in one or more non-volatile memories.

18. The method of claim 17, wherein non-volatile memories are selected from the group comprising SLC memory, MLC memory, and hard disk memory.

19. The method of claim 17, wherein determining if data is critical is based on content of the file data.

20. The method of claim 17, wherein determining if data is critical is based on access time requirement of the file data.

21. The method of claim 17, wherein determining if data is critical is based on combining content of the file data and access time requirement of the file data.

22. The method of claim 17, wherein determining if data is critical is based on one or more decision matrix tables.

23. A filter driver, comprising:
means for determining criticality of files,
means for assigning files data storage locations based upon criticality.

24. The filter driver of claim 23, wherein the criticality of files is determined based on content of the file data.

25. The filter driver of claim 23, wherein the criticality of files is determined based on the access time requirement of the file data.

26. The filter driver of claim 23, wherein the criticality of files is determined based on combining the critical nature of one or more members of the group comprising format of content of the file data, access time requirements of the file data, content of the file data, frequency of access of the file data, and wear level dependency of the data storage location.

27. The filter driver of claim 26, wherein the critical nature of the one or more members of the group is given a weight, and wherein the means for assigning file data storage is determined by artificial intelligence.
